(19) United States
(12) Patent Application Publication
(10) Pub. No.: US 2021/0284041 A1
(43) Pub. Date: Sep. 16, 2021

(54) INFORMATION PROVIDING DEVICE, INFORMATION PROVIDING METHOD, AND PROGRAM

(71) Applicant: HONDA MOTOR CO., LTD., Tokyo (JP)

(72) Inventors: Yoshikazu NISHIDA, Saitama (JP); Hirohito IDE, Saitama (JP)

(21) Appl. No.: 17/190,424

(22) Filed: Mar. 3, 2021

(30) Foreign Application Priority Data
Mar. 16, 2020 (JP) 2020-044990

(51) Int. Cl. B60L 53/66; B60Q 9/00; B60L 58/12; B60L 53/36; B60L 53/53

(52) U.S. Cl. CPC B60L 53/66; B60Q 9/00; B60L 53/53; B60L 53/36; B60L 58/12

(57) ABSTRACT

An information providing device includes a communication unit that is communicable with an onboard communication device or a terminal device of a user; a receiving unit configured to store, in a storage unit, vehicle notification information received by the communication unit; a determination unit configured to determine whether or not an electric vehicle that does not require charging and an electric vehicle that requires charging can be matched with each other; and a management unit configured to move the electric vehicle that requires charging to a vicinity of the electric vehicle that does not require charging, if the determination unit has determined that matching is possible.

This application is based on and claims the benefit of priority from Japanese Patent Application 2020-044990, filed on 16 Mar. 2020, the content of which is incorporated herein by reference.

### BACKGROUND OF THE INVENTION

### Field of the Invention

The present invention relates to an information providing device, information providing method, and program.

### Related Art

In recent years, electric vehicles such as battery electric vehicles (BEVs) and hybrid electric vehicles (HEVs) equipped with electric motors driven by rechargeable batteries are becoming popular.

Such electric vehicles may be charged at home, as well as at public charging stations installed in cities. However, when charging stations are occupied, one may have to wait a long time for one's turn. Technology for inter-vehicle charging has therefore been proposed (for example, see Patent Document 1).

Patent Document 1: Japanese Unexamined Patent Application, Publication No. 2019-126234

### SUMMARY OF THE INVENTION

Since inter-vehicle charging takes time, the waiting time for the drivers of both vehicles may become long depending on the state of charge of the rechargeable battery subject to charging.

It is an object of the present invention to provide an information providing device, information providing method, and program that improves convenience of inter-vehicle charging.

The information providing device, information providing method, and program according to the present invention employ the following configurations.

(1): An information providing device according to an aspect of the present invention includes a communication unit that is communicable with an onboard communication device or a terminal device of a user of each of a plurality of electric vehicles; a receiving unit configured to store, in a storage unit, vehicle notification information including respective vehicle identification information, position information, and information indicating a charge state of one or more electric vehicles received by the communication unit; a determination unit configured to determine, based on the vehicle notification information and electric power supply permission information received from an electric vehicle that does not require charging and the vehicle notification information received from an electric vehicle that requires charging, whether or not the electric vehicle that does not require charging and the electric vehicle that requires charging can be matched with each other; and a management unit configured to move the electric vehicle that requires charging to a vicinity of the electric vehicle that does not require charging, if the determination unit has determined that the electric vehicle that does not require charging and the electric vehicle that requires charging can be matched with each other.

(2): In the aspect described in (1) above, the determination unit determines whether or not the electric vehicle that does not require charging and the electric vehicle that requires charging can be matched with each other if the electric power supply permission information received from the electric vehicle that does not require charging includes a status permitting supply of electric power to another vehicle, and the determination unit does not determine whether or not the electric vehicle that does not require charging and the electric vehicle that requires charging can be matched with each other if the electric power supply permission information received from the electric vehicle that does not require charging includes a status not permitting supply of electric power to another vehicle.

(3): An information providing method according to an aspect of the present invention is performed by an information providing device including a communication unit that is communicable with an onboard communication device or a terminal device of a user of each of a plurality of electric vehicles, in which the method includes: storing, in a storage unit, vehicle notification information including respective vehicle identification information, position information, and information indicating a charge state of one or more electric vehicles received by the communication unit; determining, based on the vehicle notification information and electric power supply permission information received from an electric vehicle that does not require charging and the vehicle notification information received from an electric vehicle that requires charging, whether or not the electric vehicle that does not require charging and the electric vehicle that requires charging can be matched with each other; and moving the electric vehicle that requires charging to a vicinity of the electric vehicle that does not require charging, if it has been determined that the electric vehicle that does not require charging and the electric vehicle that requires charging can be matched with each other.

(4): A program according to an aspect of the present invention causes an information providing device including a communication unit that is communicable with an onboard communication device or a terminal device of a user of each of a plurality of electric vehicles to: store, in a storage unit, vehicle notification information including respective vehicle identification information, position information, and information indicating a charge state of one or more electric vehicles received by the communication unit; determine, based on the vehicle notification information and electric power supply permission information received from an electric vehicle that does not require charging and the vehicle notification information received from an electric vehicle that requires charging, whether or not the electric vehicle that does not require charging and the electric vehicle that requires charging can be matched with each other; and move the electric vehicle that requires charging to a vicinity of the electric vehicle that does not require charging, if it has been determined that the electric vehicle that does not require charging and the electric vehicle that requires charging can be matched with each other.

According to the above configurations (1) to (4), convenience of inter-vehicle charging can be improved.

### BRIEF DESCRIPTION OF THE DRAWINGS

FIG. 1 is a block diagram showing an information providing system 1 including an information providing device 100 according to an embodiment of the present invention;

FIG. 2 shows a configuration of an electric vehicle 200 according to an embodiment of the present invention;

FIG. 3 shows an example of vehicle information 151;

FIG. 4 shows an example of user information 152;

FIG. 5 shows an example of vehicle notification information 153;

FIG. 6 is a sequence chart showing a procedure of an electric power supply matching service executed in an information providing system 1 according to an embodiment of the present invention; and

FIG. 7 is a sequence chart showing a procedure of an electric power supply matching service executed in an information providing system 1 according to an embodiment of the present invention.

### DETAILED DESCRIPTION OF THE INVENTION

An embodiment of the information providing device, information providing method, and program according to the present invention is described below.

### [Information Providing System 1]

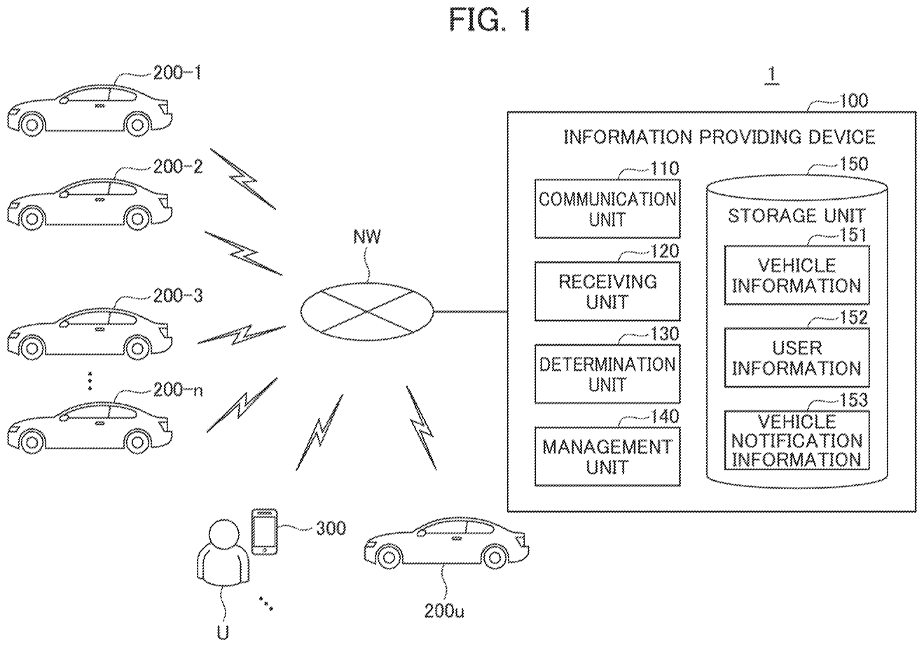

FIG. 1 is a block diagram of an information providing system 1 including an information providing device 100 according to the present embodiment. The information providing system 1 includes the information providing device 100, electric vehicles 200-1 to 200-n (n>2), one or more terminal devices 300 used by one or more users U, and one or more electric vehicles 200u used by the users U. Here, the one or more electric vehicles 200u refer to electric vehicles which are included in the electric vehicles 200-1 to 200-n and are used by the one or more users U.

In the information providing system 1, the information providing device 100, the electric vehicles 200-1 to 200-n, the one or more terminal devices 300 and the one or more electric vehicles 200u are communicably connected to one another via a network NW. The network NW includes the Internet, a wide area network (WAN), a local area network (LAN), a public communication line, a provider device, a dedicated communication line, a wireless base station, etc. In the present embodiment, the electric vehicles 200-1 to 200-n are travelling or stopped in the vicinity of the information providing device 100, or parked at a parking lot in the vicinity of the information providing device 100.

### [Electric Vehicle 200]

Next, the electric vehicles 200-1 to 200-n will be described. In the following description, a given electric vehicle of the electric vehicles 200-1 to 200-n may be referred to as an “electric vehicle 200”, or simply as an “electric vehicle”, “vehicle”, etc. without using a reference numeral. An electric vehicle 200 included in the information providing system 1 is, for example, a four-wheeled movable body. The electric vehicle 200 is equipped with a battery (rechargeable battery), and is a battery electric vehicle that travels by driving an electric motor with electric power stored in the battery, or a hybrid electric vehicle that may be driven by an electric motor.

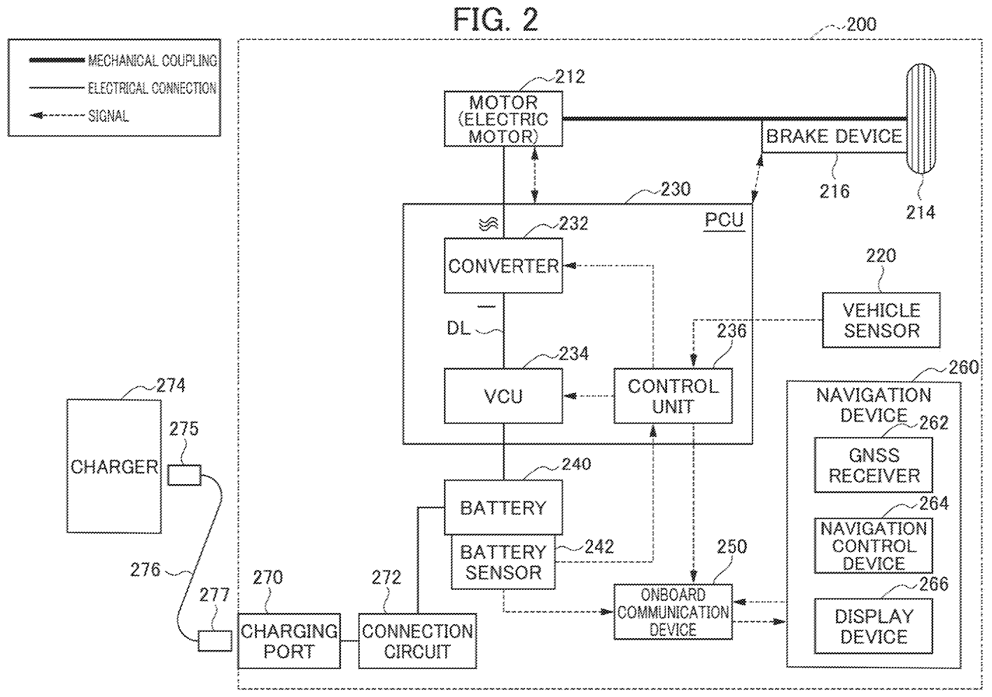

FIG. 2 shows a configuration of the electric vehicle 200 according to the present embodiment. FIG. 2 shows a configuration of an electric vehicle 200 which is not a self-driving vehicle. It should be noted that part or all of the electric vehicles 200-1 to 200-n may be self-driving vehicles. As shown in FIG. 2, the electric vehicle 200 includes a motor 212, a drive wheel 214, a brake device 216, a vehicle sensor 220, and a power control unit (PCU) 230. In addition, the electric vehicle 200 includes a battery 240, a battery sensor 242, an onboard communication device 250, a navigation device 260, a charging port 270, and a connection circuit 272.

The motor 212 is, for example, a three-phase AC electric motor. The rotor of the motor 212 is coupled to the drive wheel 214. The motor 212 outputs a driving force generated by supplied electric power to the drive wheel 214. In addition, when the electric vehicle 200 decelerates, the motor 212 uses the kinetic energy of the electric vehicle 200 to generate electricity.

The brake device 216 includes, for example, a brake caliper, a cylinder that transmits hydraulic pressure to the brake caliper, and an electric motor that generates hydraulic pressure in the cylinder. The brake device 216 may have a mechanism in which hydraulic pressure generated by an operation of a brake pedal is transmitted to the cylinder via a master cylinder. It should be noted that the brake device 216 is not limited to the configuration described above, but may also be an electronically controlled hydraulic brake device that transmits hydraulic pressure of a master cylinder to the cylinder.

The vehicle sensor 220 includes an accelerator opening sensor, a vehicle speed sensor, and a brake depression amount sensor. The accelerator opening sensor is an example of an operation unit that receives an acceleration instruction from the driver of the vehicle. The accelerator opening sensor is attached to the accelerator pedal, detects an operation amount of the accelerator pedal, and outputs the detected operation amount of the accelerator pedal as an accelerator opening to a control unit 236. The vehicle speed sensor includes, for example, a wheel speed sensor and a speed calculator attached to each vehicle wheel, combines wheel speeds detected by the wheel speed sensors to calculate the speed of the electric vehicle (vehicle speed), and outputs the vehicle speed to the control unit 236. The brake depression amount sensor is attached to the brake pedal, detects an operation amount of the brake pedal, and outputs the detected operation amount of the brake pedal as a brake depression amount to the control unit 236.

The PCU 230 includes a converter 232, a voltage control unit (VCU) 234, and the control unit 236. In FIG. 2, these elements are shown combined into the single configuration of the PCU 230 merely by way of example. Part or all of these elements may be arranged dispersed in the interior of the electric vehicle 200.

The converter 232 is, for example, an AC-DC converter. The DC terminal of the converter 232 is connected to a DC link DL. The DC link DL is connected to the battery 240 via the VCU 234. The converter 232 converts an alternating current generated by the motor 212 into a direct current and outputs the direct current to the DC link. DL. The VCU 234 is, for example, a DC-DC converter. The VCU 234 boosts the voltage of the electric power supplied from the battery 240 and outputs the electric power to the DC link DL.

The control unit 236 includes, for example, a motor control unit, a brake control unit, and a battery/VCU control unit, etc. The motor control unit, the brake control unit, and the battery/VCU control unit may be replaced with respective separate control devices, for example, a motor ECU, a brake ECU, a battery ECU, etc.

The motor control unit controls the motor 212 based on the output from the vehicle sensor 220. The brake control unit controls the brake device 216 based on the output from the vehicle sensor 220. The battery/VCU control unit calculates the SOC (state of charge) of the battery 240 based on the battery sensor 242 attached to the battery 240, and outputs the calculated result of the SOC to the VCU 234 and the onboard communication device 250. The SOC is an example of information indicating the charge state of the battery 240. The VCU 234 steps up the voltage of the DC link DL according to an instruction from the battery/VCU control unit.

The battery 240 is, for example, a rechargeable battery such as a lithium-ion battery or the like. The battery 240 accumulates electric power introduced from a charger 274 outside of the electric vehicle 200, and discharges electric power so that the electric vehicle 200 can travel.

The navigation device 260 includes, for example, a GNSS receiver 262, a navigation control device 264, and a display device 266. The GNSS receiver 262 measures its own position (the position of the electric vehicle 200) based on a signal from a GNSS satellite (e.g., a GPS satellite). The navigation control device 264 includes, for example, a CPU and any kind of storage device, and controls the entirety of the navigation device 260. The storage device stores map information (navigation map). The navigation map is a map that expresses roads as nodes and links.

The navigation control device 264 determines a route from the position of the electric vehicle 200 measured by the GNSS receiver 262 to a destination, with reference to the navigation map. Here, the destination may be designated using, for example, position information of the electric vehicle 200 included in an electric power supply disclosure notification (described later). In addition, the navigation control device 264 may transmit the position of the electric vehicle 200 and the destination to a navigation server (not shown) using the onboard communication device 250, and acquire a route returned by the navigation server. Further, the route may include information regarding a parked position of an electric vehicle 200 of a user who has permitted an electric power supply (also referred to hereinafter as “electric power supply-side electric vehicle”) at a parking lot. The navigation control device 264 outputs information regarding the route determined by either of the above methods to the display device 266.

The display device 266 displays information as controlled by the navigation control device 264. The display device 266 displays a navigation screen according to the information output from the navigation control device 264. The display device 266 displays, for example, a route for an electric vehicle 200 of a user who has requested an electric power supply (also referred to hereinafter as “electric power receiving-side electric vehicle”) to reach the electric power supply-side electric vehicle 200. In addition, the GNSS receiver 262 outputs position information, which is the measured result of the position of the electric vehicle 200, to the onboard communication device 250.

The battery sensor 242 includes sensors such as, for example, a current sensor, a voltage sensor, a temperature sensor, etc. The battery sensor 242 detects, for example, a current value, a voltage value, and a temperature of the battery 240. The battery sensor 242 outputs information indicating the detected current value, voltage value, and temperature to the control unit 236 and the onboard communication device 250. The battery sensor 242 may include a plurality of each of the current sensor, the voltage sensor, the temperature sensor, etc. If the battery sensor 242 includes a plurality of sensors, the information indicating the current value, the voltage value, and the temperature to be output to the control unit 236 may include battery sensor identifiers. The battery sensor identifiers are identifiers that allow for identification of the plurality of sensors of the electric vehicle 200. The battery sensor identifiers may, for example, be represented by alphanumeric characters determined in advance.

The onboard communication device 250 includes a wireless module for connecting to the Internet, a WAN, a LAN, a public communication line, a provider device, a dedicated communication line, a wireless base station, etc. The onboard communication device 250 acquires the information indicating the current value, the voltage value, and the temperature output by the battery sensor 242. In addition, the onboard communication device 250 acquires the calculated result of the SOC output by the control unit 236. The onboard communication device 250 acquires the position information of the electric vehicle 200 output by the GNSS receiver 262. The onboard communication device 250 acquires battery identification information stored as internal information.

When a user has performed an operation with respect to the terminal device 300 to disclose that the user permits an electric power supply, the onboard communication device 250 creates an electric power supply disclosure notification addressed to the information providing device 100, the electric power supply disclosure notification including vehicle notification information including vehicle identification information, information indicating the charge state of the vehicle, and vehicle position information, and electric power supply permission information. Vehicle position information includes, for example, information indicating a parked position of an electric power supply-side electric vehicle 200 at a parking lot. Electric power supply permission information is information indicating whether or not a supply of electric power is permitted. When the user permits supply of electric power to another electric vehicle, the status of the electric power supply permission information is set to “ON”. The electric power supply disclosure notification may also include information indicating electric power supply conditions such as how long the vehicle has been stopped, a charging method, a usage fee, etc. In the present embodiment, the electric power supply-side electric vehicle 200 represents an “electric vehicle that does not require charging”.

In addition, when the user has performed an operation with respect to the terminal device 300 to request an electric power supply, the onboard communication device 250 creates a charge request notification addressed to the information providing device 100, the charge request notification including vehicle notification information including vehicle identification information, information indicating the charge state of the vehicle, and vehicle position information, and information requesting a charge. In the present embodiment, the electric power receiving-side electric vehicle 200 represents an “electric vehicle that requires charging”. The onboard communication device 250 transmits the created electric power supply disclosure notification or charge request notification to the information providing device 100 via the network NW shown in FIG. 1.

The charging port 270 is provided oriented toward the vehicle exterior of the electric vehicle 200. The charging port 270 is connected to the charger 274 via a charging cable 276. The charging cable 276 includes a first plug 275 and a second plug 277. The first plug 275 is connected to the charger 274, and the second plug 277 is connected to the charging port 270. Electricity from the charger 274 is supplied to the charging port 270 via the charging cable 276. The charger 274 is an example of a charging facility. The charging cable 276 further includes a signal cable added to the electric power cable. The signal cable mediates communication between the electric vehicle 200 and the charger 274. Therefore, each of the first plug 275 and the second plug 277 is provided with an electric power connector and a signal connector.

The connection circuit 272 is provided between the charging port 270 and the battery 240. The connection circuit 272 transmits a current, for example, a direct current, introduced from the charger 274 via the charging port 270. The connection circuit 272 transmits the direct current to the battery 240.

### [Information Providing Device 100]

The information providing device 100 is a device that provides an electric power supply matching service to an electric vehicle 200 that has transmitted an electric power supply disclosure notification and an electric vehicle 200 that has transmitted a charge request notification. The functions of the information providing device 100 are realized by, for example, a personal computer, a server, an industrial computer, etc. As shown in FIG. 1, the information providing device 100 includes a communication unit 110, a receiving unit 120, a determination unit 130, a management unit 140, and a storage unit 150.

The communication unit 110 is realized by a communication module. Specifically, the communication unit 110 is composed of a device performing wired communication. The communication unit 110 may also be composed of a wireless device compatible with wireless communication technologies such as LTE®, wireless LAN, etc. Via the network NW, the communication unit 110 performs communication between the terminal device 300 of a user U and the onboard communication device 250 included in the electric vehicle 200.

When the receiving unit 120 has acquired an electric power supply disclosure notification output by the communication unit 110, the receiving unit 120 outputs the acquired electric power supply disclosure notification to the determination unit 130. The receiving unit 120 acquires the vehicle identification information, the information indicating the charge state of the vehicle, and the vehicle position information included in the vehicle notification information of the acquired electric power supply disclosure notification, and stores these pieces of information in association with each other in the storage unit 150 as vehicle notification information 153 (described later). The receiving unit 120 executes the same process when it has acquired a charge request notification from the communication unit 110.

Based on the electric power supply disclosure information transmitted by the electric power supply-side electric vehicle and the charge request notification transmitted by the electric power receiving-side electric vehicle, the determination unit 130 determines whether or not the electric power supply-side electric vehicle and the electric power receiving-side electric vehicle can be matched with each other. The detailed functions of the determination unit 130 will be described later.

If the determination unit 130 has determined that the electric power supply-side electric vehicle and the electric power receiving-side electric vehicle can be matched with each other, the management unit 140 causes the electric power receiving-side electric vehicle to move to the vicinity of the electric power supply-side electric vehicle. The detailed functions of the management unit 140 will be described later.

The storage unit 150 is realized by a hard disk drive (HDD), a flash memory, a random-access memory (RAM), a read only memory (ROM), etc. The storage unit 150 stores, for example, vehicle information 151, user information 152, and vehicle notification information 153 described below, as well as map information (navigation map). It should be noted that part or all of this information may be stored in a storage device connected to the network NW.

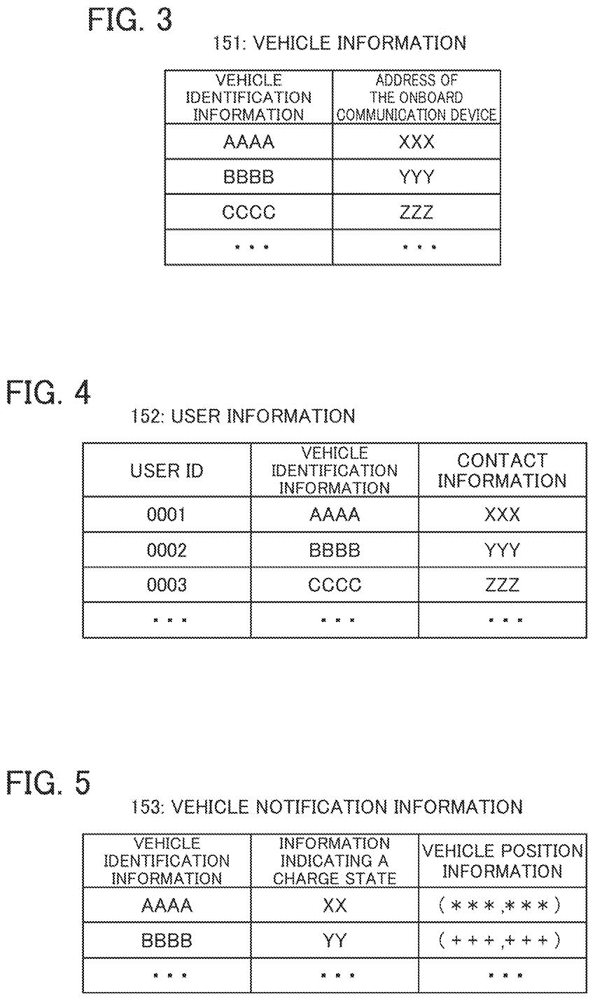

Here, a specific example of vehicle information 151, user information 152, and vehicle notification information 153 stored in the storage unit 150 will be described. FIG. 3 shows an example of vehicle information 151. The vehicle information 151 is information in a table format, in which vehicle identification information of electric vehicles 200 and the addresses of the onboard communication devices installed in the electric vehicles 200 are associated with each other. An example of an address of an onboard communication device is an IP address. This information is registered when an electric vehicle 200 is introduced into the information providing system 1.

FIG. 4 shows an example of user information 152. The user information 152 is information in a table format, in which user IDs, vehicle identification information of the electric vehicles 200 used by the users corresponding to the user IDs, and contact information of the users corresponding to the user IDs are associated with each other. An example of contact information of a user is an email address. This information is registered when a user begins using an electric vehicle 200.

FIG. 5 shows an example of vehicle notification information 153. The vehicle notification information 153 is information in a table format, in which vehicle identification of electric vehicles 200, information indicating charge states of the electric vehicles 200, and vehicle position information of the electric vehicles 200 are associated with each other. The vehicle position information of an electric vehicle 200 is, for example, represented by latitude and longitude of map information (navigation map). The information indicating the charge state of an electric vehicle 200 is, for example, represented by the SOC (state of charge) of the battery 240 installed in the electric vehicle 200.

The aforementioned receiving unit 120, determination unit 130, and management unit 140 are realized by a hardware processor such as, for example, a central processing unit (CPU) executing a program (software) stored in the storage unit 150. Further, part or all of these functions may be realized by hardware (including circuitry) such as large-scale integration (LSI), an application specific integrated circuit (ASIC), a field-programmable gate array (FPGA), a graphics processing unit (GPU), etc., or by cooperation of software and hardware. The program may be stored in advance in a storage device (a storage device including a non-transitory storage medium) such as a hard disk drive (HDD) or a flash memory etc., or it may be stored on a removable storage medium (a non-transitory storage medium) such as a DVD or CD-ROM, and may be installed by inserting the storage medium into a drive device.

### [Terminal Device 300]

The terminal device 300 is, for example, a smart phone, tablet device, or personal computer, etc. owned by the user. An application program, browser, or the like for using the information providing system 1 is activated on the terminal device 300 to support various functions and operations. An example of the terminal device 300 is a smart phone, which is presumed to be running an application program.

### [Operation of the Information Providing System 1]

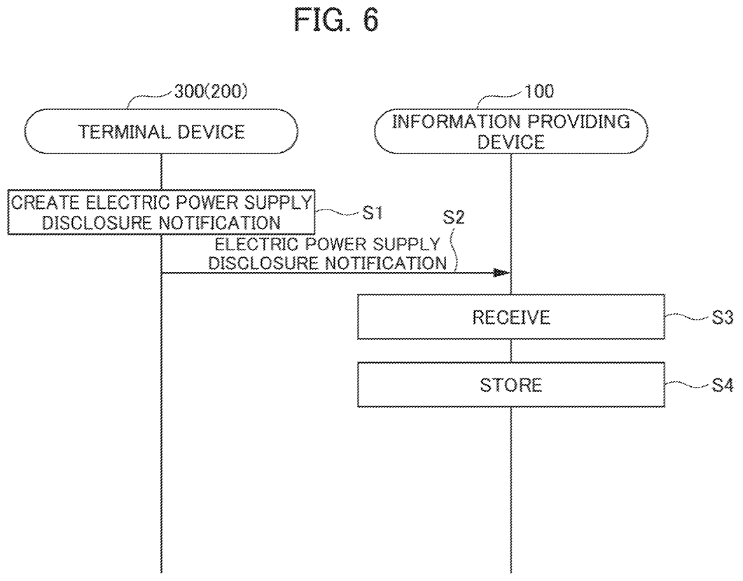

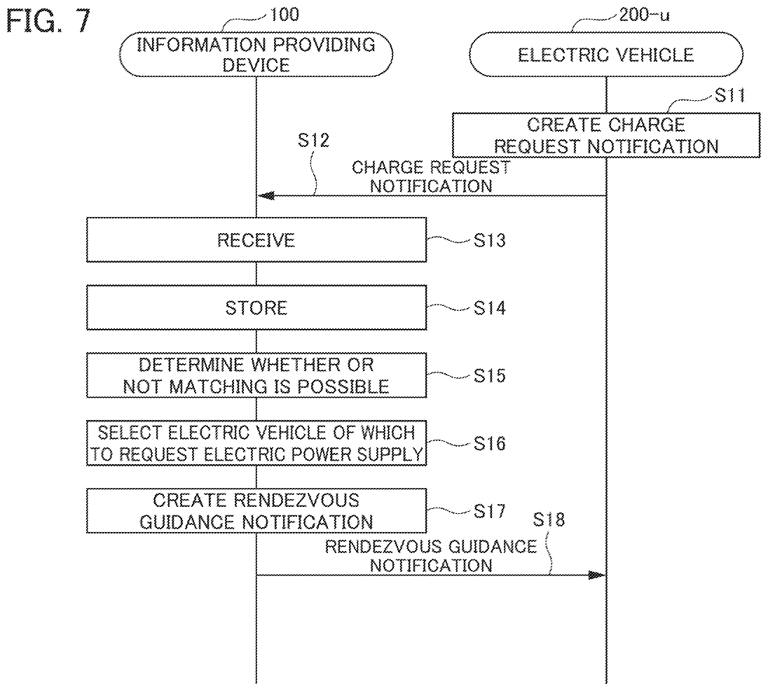

FIG. 6 and FIG. 7 are sequence charts showing a procedure of an electric power supply matching service executed by the information providing system 1 according to the present embodiment. Described first, with reference to the sequence chart shown in FIG. 6, is a procedure in the information providing system 1 when the information providing device 100 has received an electric power supply disclosure notification from one or more electric vehicles 200.

Of the electric vehicles 200-1 to 200-n, a user who permits electric power supply to another vehicle performs an operation via the terminal device 300 to disclose that the user permits the electric power supply. When the operation to disclose permission of the electric power supply has been performed by the user, the terminal device 300 creates an electric power supply disclosure notification addressed to the information providing device 100, the electric power supply disclosure notification including vehicle notification information including vehicle identification information, information indicating a charge state of the vehicle, and vehicle position information, and electric power supply permission information (status: ON) (Step S1). The terminal device 300 transmits the created electric power supply disclosure notification to the information providing device 100 (Step S2).

At the information providing device 100, the communication unit 110 receives the electric power supply disclosure notification from a user permits the electric power supply (Step S3). At the information providing device 100, the communication unit 110 outputs the received electric power supply disclosure notification to the receiving unit 120. The receiving unit 120 acquires the electric power supply disclosure notification output by the communication unit 110, and acquires the vehicle identification information, information indicating a charge state of the vehicle, and vehicle position information included in the acquired electric power supply disclosure notification, and acquires the electric power supply permission information. The receiving unit 120 stores the acquired vehicle identification information, information indicating a charge state of the vehicle, vehicle position information, and electric power supply permission information in association with each other as vehicle notification information 153 in the storage unit 150 (Step S4). If there are one or more electric power supply-side electric vehicles 200, a respective electric power supply disclosure notification is transmitted from each electric power supply-side electric vehicle 200. In that case, the information providing device 100 performs the same process as in Steps S1 to S4 for each electric power supply disclosure notification transmitted from the electric vehicles 200.

Described next, with reference to the sequence chart shown in FIG. 7, is a procedure in the information providing system 1 when the information providing device 100 has received a charge request notification from a user. Described here is matching of an electric vehicle 200u of a user U who requests a charge and an electric power supply-side electric vehicle 200.

The user U who requests a charge performs an operation via the terminal device 300 to request a charge from another electric vehicle 200. When the operation to request a charge has been performed by the user U, the terminal device 300 creates a charge request notification addressed to the information providing device 100, the charge request notification including vehicle notification information of the electric vehicle 200u and information requesting a charge (Step S11). The terminal device 300 transmits the created charge request notification to the information providing device 100 (Step S12).

At the information providing device 100, the communication unit 110 receives the charge request notification transmitted by the terminal device 300 (Step S13). At the information providing device 100, the communication unit 110 outputs the received charge request notification to the receiving unit 120. The receiving unit 120 acquires the charge request notification output by the communication unit 110, and acquires the vehicle identification information, information indicating a charge state of the vehicle, and vehicle position information included in the vehicle notification information of the acquired charge request notification. The receiving unit 120 stores the acquired vehicle identification information, information indicating a charge state of the vehicle, and vehicle position information in association with each other as vehicle notification information 153 in the storage unit 150 (Step S14). Based on the vehicle identification information assigned to each electric vehicle 200, the vehicle notification information 153 is stored as information on the electric vehicle 200u that has requested a charge.

At the information providing device 100, the determination unit 130 determines, based on the electric power supply disclosure information of the electric power supply-side electric vehicle 200 and the charge request notification of the electric power receiving-side electric vehicle 200u, whether or not the electric power supply-side electric vehicle 200 and the electric power receiving-side electric vehicle 200u can be matched with each other (Step S15).

It should be noted that the determination unit 130 determines whether or not the electric power supply-side electric vehicle 200 and the electric power receiving-side electric vehicle 200u can be matched with each other if the electric power supply permission information included in the electric power supply disclosure notification of the electric power supply-side electric vehicle 200 includes a status permitting supply of electric power to another vehicle (ON). On the other hand, if the electric power supply permission information included in the electric power supply disclosure notification of the electric power supply-side electric vehicle 200 includes a status not permitting supply of electric power to another vehicle (OFF), the determination unit 130 does not determine whether or not the electric power supply-side electric vehicle 200 and the electric power receiving-side electric vehicle 200u can be matched with each other.

The determination unit 130 calculates a distance between the electric power receiving-side electric vehicle 200u and the electric power supply-side electric vehicle 200 based on the vehicle position information acquired from the vehicle notification information 153 of the electric power supply-side electric vehicle 200. If the calculated distance is equal to or less than a threshold, the determination unit 130 determines that one condition for matching has been satisfied.

Based on the information indicating a charge state acquired from the vehicle notification information 153 of the same electric power supply-side electric vehicle 200, the determination unit 130 determines that another condition for matching has been satisfied if the SOC (state of charge) is equal to or more than an SOC threshold. The SOC threshold is determined with consideration to whether a necessary minimum SOC is ensured in the electric power supply-side electric vehicle 200 after supplying electric power to the electric power receiving-side electric vehicle 200u.

The determination unit 130 determines other compatibility conditions between vehicles, for example, whether or not the standards, charging methods, etc. of the batteries 240 installed in the electric vehicles 200 match, and determines that the vehicles can be matched with each other if all of these conditions match. If there are multiple electric power supply-side electric vehicles 200, the determination unit 130 matches the electric power receiving-side electric vehicle 200u with each of the electric vehicles 200. If matching is possible with a plurality of electric vehicles 200, the determination unit 130 selects one vehicle from the plurality of electric vehicles 200. For example, the electric vehicle 200 at the shortest distance from the electric power receiving-side electric vehicle 200u may be selected, or the electric vehicle 200 with the highest SOC (state of charge) may be selected. The determination unit 130 selects an electric vehicle 200 of which to request an electric power supply from the one or more electric vehicles 200 (Step S16). Hereinafter, the electric vehicle 200 of which to request an electric power supply is also referred to as an “electric power supply-side electric vehicle 200”.

The management unit 140 acquires the vehicle notification information of the electric power receiving-side electric vehicle 200u, the vehicle notification information of the electric power supply-side electric vehicle 200, and the map information etc. stored in the storage unit 150, and, based on this information, identifies a location where the electric power receiving-side electric vehicle 200u can rendezvous with the electric power supply-side electric vehicle 200, for example, a parking space at a parking lot next to the electric power supply-side electric vehicle 200 (rendezvous point), and creates a rendezvous guidance notification including position information of this location (Step S17).

The management unit 140 outputs the created rendezvous guidance notification to the communication unit 110. The communication unit 110 transmits the rendezvous guidance notification output from the management unit 140 to the electric power receiving-side electric vehicle 200u (Step S18). Although not shown here, the management unit 140 transmits a notification to the electric power supply-side electric vehicle 200 to notify that the electric power receiving-side electric vehicle 200u is about to reach the vicinity.

Thereafter, the navigation device 260 of the electric vehicle 200u that has requested a charge guides the driver to the parking space that is to be the rendezvous point based on the position information etc. included in the rendezvous guidance notification. This lets the driver of the electric power receiving-side electric vehicle 200u stop the vehicle in the parking space next to the electric power supply-side electric vehicle 200, allowing for electric power supply to be performed between the electric vehicles. This electric power supply may be done using the charging cable 276 (see FIG. 2), or by wireless electric power supply.

According to the information providing device 100 of the embodiment described above, the user who has permitted an electric power supply can utilize his or her spare time to supply electric power to other electric vehicles by parking his or her vehicle at a parking lot, etc. Further, the user who has requested a charge can immediately receive an electric power supply from a vehicle with a high state of charge at a nearby parking lot, without having to wait at a charging station. Accordingly, the information providing device 100 according to the present embodiment can improve convenience of inter-vehicle charging.

In the information providing device 100 according to the present embodiment, if the electric power supply permission information included in the electric power supply disclosure notification of the electric power supply-side electric vehicle includes a status not permitting supply of electric power to another vehicle (OFF), the determination unit 130 does not determine whether the electric power supply-side electric vehicle and the electric power receiving-side electric vehicle can be matched. Therefore, in the information providing device 100 according to the present embodiment, it is possible to reduce problems such as erroneously guiding the electric power receiving-side electric vehicle to the vicinity of an electric vehicle that has not permitted the electric power supply.

An embodiment of the present disclosure has been described above, but the present disclosure is not limited to the aforementioned embodiment, and various modifications and changes as described below are possible, which are also included in the technical scope of the present disclosure. In addition, the effects described in the embodiment is merely a list of the most preferred effects exhibited by the present disclosure, and are not limited to the effects described in the embodiment.

If the electric power supply disclosure notification received from the electric power supply-side electric vehicle 200 includes information indicating a usage fee as an electric power supply condition, the information providing device 100 may transmit this information to the terminal device 300 of the user who has requested a charge, and only determine whether matching is possible if consent is given. If the electric power supply-side electric vehicle 200 is moved to another location during wireless electric power supply, the information providing device 100 may select a new electric vehicle 200 of which to request an electric power supply and transmit a rendezvous guidance notification for rendezvousing with this electric vehicle 200 to the electric power receiving-side electric vehicle 200u.

Electric power transfer may be temporarily stopped if a person passes between the vehicles during a wireless electric power supply. A person passing between the vehicles can be detected by a peripheral detection device (e.g., a human presence sensor) provided to either of the electric vehicles.

When determining whether matching is possible, the determination unit 130 of the information providing device 100 refers to the information indicating a charge state of the vehicle, and determines that one condition for matching is not satisfied if the SOC of the vehicle is less than the SOC threshold. However, with a hybrid vehicle, it is possible to supply electric power to another vehicle while driving the engine even if the SOC is low. In that case, the user of a hybrid vehicle who wants to provide electric power to another vehicle includes information indicating that electric power will be supplied while driving the engine in the electric power supply disclosure notification to be transmitted. This causes the determination unit 130 to determine that one condition for matching regarding the charge state of the vehicle has been satisfied even if the SOC is less than the SOC threshold, which increases the likelihood that the electric vehicle is selected as the electric power supply-side electric vehicle.

### EXPLANATION OF REFERENCE NUMERALS

1 Information providing system
100 Information providing device
110 Communication unit
120 Receiving unit
130 Determination unit
140 Management unit
150 Storage unit
200-1 to 200-n, 200, 200u Electric vehicle
240 Battery
250 Onboard communication device
260 Navigation device
300 Terminal device
NW Network

What is claimed is:

1. An information providing device comprising:
a communication unit that is communicable with an onboard communication device or a terminal device of a user of each of a plurality of electric vehicles;
a receiving unit configured to store, in a storage unit, vehicle notification information including respective vehicle identification information, position information, and information indicating a charge state of one or more electric vehicles received by the communication unit;
a determination unit configured to determine, based on the vehicle notification information and electric power supply permission information received from an electric vehicle that does not require charging and the vehicle notification information received from an electric vehicle that requires charging, whether or not the electric vehicle that does not require charging and the electric vehicle that requires charging can be matched with each other; and
a management unit configured to move the electric vehicle that requires charging to a vicinity of the electric vehicle that does not require charging, if the determination unit has determined that the electric vehicle that does not require charging and the electric vehicle that requires charging can be matched with each other.

2. The information providing device according to claim 1, wherein:
the determination unit determines whether or not the electric vehicle that does not require charging and the electric vehicle that requires charging can be matched with each other if the electric power supply permission information received from the electric vehicle that does not require charging includes a status permitting supply of electric power to another vehicle, and
the determination unit does not determine whether or not the electric vehicle that does not require charging and the electric vehicle that requires charging can be matched with each other if the electric power supply permission information received from the electric vehicle that does not require charging includes a status not permitting supply of electric power to another vehicle.

3. An information providing method performed by an information providing device including a communication unit that is communicable with an onboard communication device or a terminal device of a user of each of a plurality of electric vehicles, the method comprising:
storing, in a storage unit, vehicle notification information including respective vehicle identification information, position information, and information indicating a charge state of one or more electric vehicles received by the communication unit;
determining, based on the vehicle notification information and electric power supply permission information received from an electric vehicle that does not require charging and the vehicle notification information received from an electric vehicle that requires charging, whether or not the electric vehicle that does not require charging and the electric vehicle that requires charging can be matched with each other; and
moving the electric vehicle that requires charging to a vicinity of the electric vehicle that does not require charging, if it has been determined that the electric vehicle that does not require charging and the electric vehicle that requires charging can be matched with each other.

4. A non-transitory computer readable medium storing a program that causes an information providing device including a communication unit that is communicable with an onboard communication device or a terminal device of a user of each of a plurality of electric vehicles to:
store, in a storage unit, vehicle notification information including respective vehicle identification information, position information, and information indicating a charge state of one or more electric vehicles received by the communication unit;
determine, based on the vehicle notification information and electric power supply permission information received from an electric vehicle that does not require charging and the vehicle notification information received from an electric vehicle that requires charging, whether or not the electric vehicle that does not require charging and the electric vehicle that requires charging can be matched with each other; and
move the electric vehicle that requires charging to a vicinity of the electric vehicle that does not require charging, if it has been determined that the electric vehicle that does not require charging and the electric vehicle that requires charging can be matched with each other.
